(19) United States
(12) Patent Application Publication
(10) Pub. No.: US 2015/0302465 A1
(43) Pub. Date: Oct. 22, 2015

(54) TRACKING USER ACTIVITIES UTILIZING HTTP REFERRERS

(71) Applicant: YIELDBOT INC., New York, NY (US)

(72) Inventor: Keith Pieper, Louisville, CO (US)

(21) Appl. No.: 14/689,572

(22) Filed: Apr. 17, 2015

Related U.S. Application Data
(60) Provisional application No. 61/981,501, filed on Apr. 18, 2014.

(51) Int. Cl. G06Q 30/02

(52) U.S. Cl. CPC G06Q 30/0244; G06Q 30/0277

(57) ABSTRACT

A system comprising a server including a memory device having executable instructions stored therein and a processing device, in response to the executable instructions, configured to receive a content request from a destination webpage server, the content request including a Hypertext Transport Protocol (HTTP) header, identify a referrer from a referrer field of the HTTP header, the referrer indicating an originating webpage, determine a frequency the referrer has been identified from prior page requests in a given time period, compare the frequency with a configuration value indicating a max frequency for presentation of one or more content to content requests associated with the referrer, select content to be delivered to the destination webpage server based on the comparison, and modify the content to be delivered based at least on exhausting the max frequency for presentation of one or more content to content requests associated with the referrer.

### CROSS REFERENCE TO RELATED APPLICATION

This application claims the priority of U.S. Provisional Application No. 61/981,501, entitled “REFERRER BASED REACH AND FREQUENCY CONTROL,” filed on Apr. 18, 2014, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The invention described herein generally relates to determining data about user activities on the Internet, and in particular, utilizing referrers to determine online browsing and navigation activities.

2. Description of the Related Art

Using cookies, IP addresses, device fingerprinting, and/or other methods to target and track individual users on the Internet to collect data presents numerous challenges. One challenge is related to the users' anonymity and privacy. Cookies can be used to track user activity at a browser level, while IP addresses and device fingerprints can track user activity at a computer level. All of these have been proven to enable traceability back to a single individual user or group of users associated with the browser or the computer. Hence these tracking tools are not anonymous, which can pose legal and policy challenges for many advertisers.

Another challenge is the reliability of the data. For example, cookies can be disabled, blocked or deleted by the users. More specifically, with each cookie deletion and a subsequent web visit, a new “user” is counted, artificially inflating reach counts and underestimating the frequency for a given user. While not being susceptible to deletion like cookies, many IP addresses on a given computer are dynamic and change frequently, making the IP address an unreliable tracking tool. Further, cookies and IP addresses are associated with an individual browser or an individual computer, which may be accessed by one or multiple individual users. Device fingerprinting may be more stable than cookies or IP addresses at tracing individual users' activity. However, each change in software, plug-in updates, and installations on a computer may yield a new fingerprint and a new user yielding an inaccurate tracking.

User tracking has several uses such as measuring reach and frequency (R&F). R&F is relied upon, for example, to measure the effectiveness of advertising campaigns. Media is typically purchased based on R&F. Reach generally refers to the number of unique recipients of a given message or advertisement. Frequency generally refers to how often an advertisement is shown to a unique user over a given period of time. In offline media, the combination of reach and frequency is also known as gross rating points (GRP). Typically, reach is a function of the percentage of users reached in a given audience multiplied by the frequency to yield the GRP. For example, a television advertisement may reach 25 percent of households three times over a given month, which would yield a GRP of 75 “points” for that television advertisement.

However, in online or digital media channels, reach and frequency are calculated differently. Digital channels have the benefit of more granular measurement and tracking capability since digital channels can measure and target specific individual users' activity whereas offline channels cannot (and use some proxy measure instead). For example, the browser cookies, internet protocol (IP) addresses, and/or device fingerprints can be used to target and track specific individuals' activity. For example, a given ad campaign can reach 1 million users with an ad three times in a given month (as opposed to a certain percentage of users from households), hence the notion of “points” as a proxy measurement is not needed. However, given the described challenges in using these online tracking methods, R&F measurement may be inaccurate and unreliable. As such, there is a need for improved online user tracking.

### SUMMARY OF THE INVENTION

The present invention provides a system comprising a server including a memory device having executable instructions stored therein and a processing device, in response to the executable instructions, configured to receive a content request from a destination webpage server, the content request including a Hypertext Transport Protocol (HTTP) header, identify a referrer from a referrer field of the HTTP header, the referrer indicating an originating webpage, determine a frequency the referrer has been identified from prior page requests in a given time period, compare the frequency with a configuration value indicating a max frequency for presentation of one or more content to content requests associated with the referrer, select content to be delivered to the destination webpage server based on the comparison, and modify the content to be delivered based at least on exhausting the max frequency for presentation of one or more content to content requests associated with the referrer.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates an exemplary referral traffic report utilized for an advertising campaign according to an embodiment of the present invention.

FIG. 2 illustrates flow diagram for a referrer-based content server system according to an embodiment of the present invention.

FIG. 3 illustrates an exemplary advertising campaign creation screen for creating a unique advertising campaign according to an embodiment of the present invention.

FIG. 4 illustrates a flow chart for operating a referrer-based advertising campaign according to an embodiment of the present invention.

FIG. 5 illustrates a computer system according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

Embodiments of the present invention provide techniques and systems for online content navigation tracking based on an identification of a referrer. A referrer (http-referrer or referer), as used herein, is generally intended to refer to a Hypertext Transport Protocol (HTTP) header field that identifies the address of the webpage (i.e., the Universal Resource Identifier (URI), Universal Resource Link (URL), or Internationalized Resource Identifier (IRI)) that links to a resource being requested. Advertising content includes advertising for goods and/or services occurring over a network including one or more local area networks (LANs) or a wide area network (WAN), for example, the Internet. Any reference herein to “online advertising” may generally include any such advertising occurring over a network and is not limited to advertising over the Internet. Advertising content can include text, graphics, animation, audio, video, software code or scripts (such as Javascript, Adobe Flash, or other executable code), links and/or other information that is provided to the target audience when the ad is displayed. Further, the techniques and systems described herein can be used to distribute content over other distribution media (e.g., not online), including those over broadcast, wireless, radio or other distribution networks.

An advertising campaign includes one or more advertisements, as well as information describing presentation of the one or more advertisements. This information may include targeting criteria identifying characteristics of users to which an advertiser desires to present advertisements and a budget specifying an amount the advertiser is willing to spend to distribute advertisements in the advertising campaign. Conducting a successful online advertising campaign can be facilitated with the benefit of institutional knowledge such as knowledge and/or experience as to effective ad placement, distribution, and pricing. Ad placement involves deciding where, when or under what circumstances the ad should be displayed. Targeting criteria can be used to define the ad placement. For example, for a keyword-based advertising campaign, the targeting criteria can include one or more keywords that trigger the ad being provided to a potential audience by placement on a webpage, for example, a search engine's search results webpage. As another example, for a site-based advertising campaign, the targeting criteria can include a list of one or more URLs (Universal Resource Locators) of target websites on which to place an ad (sometimes referred to as a “white list”). Other types of targeting criteria can be used, and the ones described are but examples.

According to embodiments of the present invention, by checking the referrer, a webpage (server) can see where a request to the webpage originated. When a user clicks a hyperlink or an originating webpage in a web browser, the web browser sends a request to the server holding the destination webpage. Links between sites are typically content referrers. The request may include a referrer field, which indicates the last page the user was on (e.g., the originating webpage or the page where the user clicked the hyperlink linking to the destination webpage in addition to any explicit keywords of users' queries, site data of the last page, and the page-level of the last page upon redirect). For example, “www.search.yahoo.com/search;_ylt=movie_times” may indicate a particular query a user has entered into a search engine. In the case of search referrers, keywords may also be extracted, since the originating user keyword query becomes appended to the referrer. Further description and details of keyword extraction may be found in U.S. Patent Publication No. 2009/0089278 entitled “TECHNIQUES FOR KEYWORD EXTRACTION FROM URLS USING STATISTICAL ANALYSIS” and U.S. Pat. No. 6,882,999 entitled “URL MAPPING METHODS AND SYSTEMS,” which are hereby incorporated by reference in its entirety.

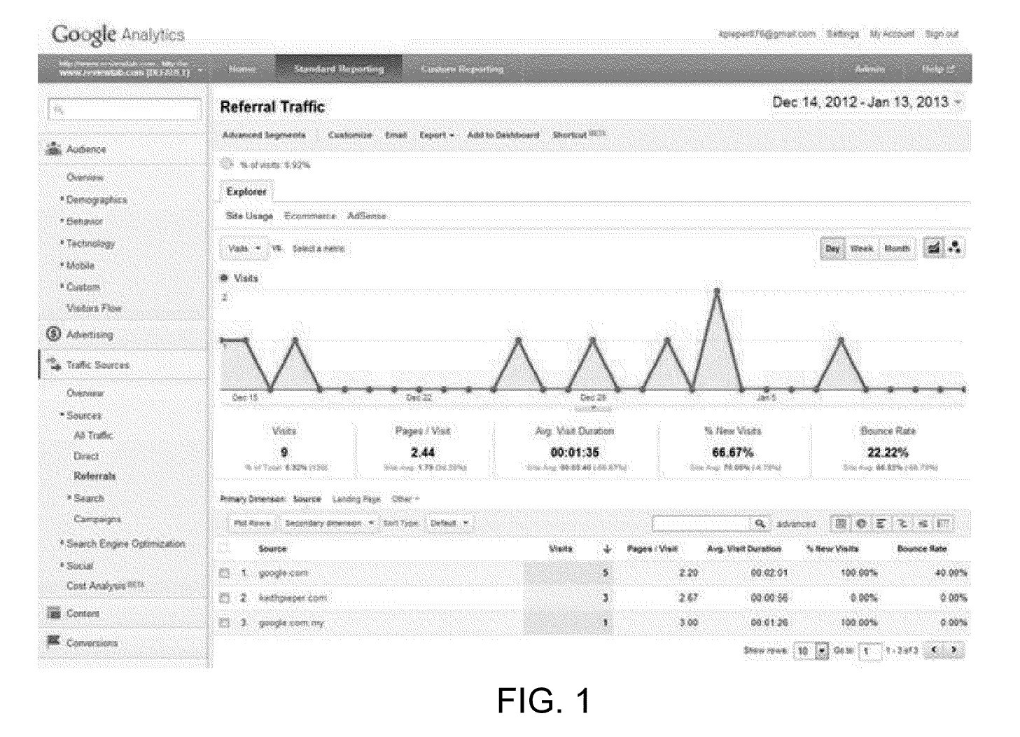

Referrers can be used for web statistics and analytics packages by services such as Adobe Site Catalyst, Google Analytics and Webtrends. Each of these services have reports that display “traffic sources” and usually break the sources into “search,” “content” and “direct,” corresponding to different types of referrers. FIG. 1 illustrates an exemplary referral traffic report that may be utilized for an advertising campaign according to an embodiment of the present invention.

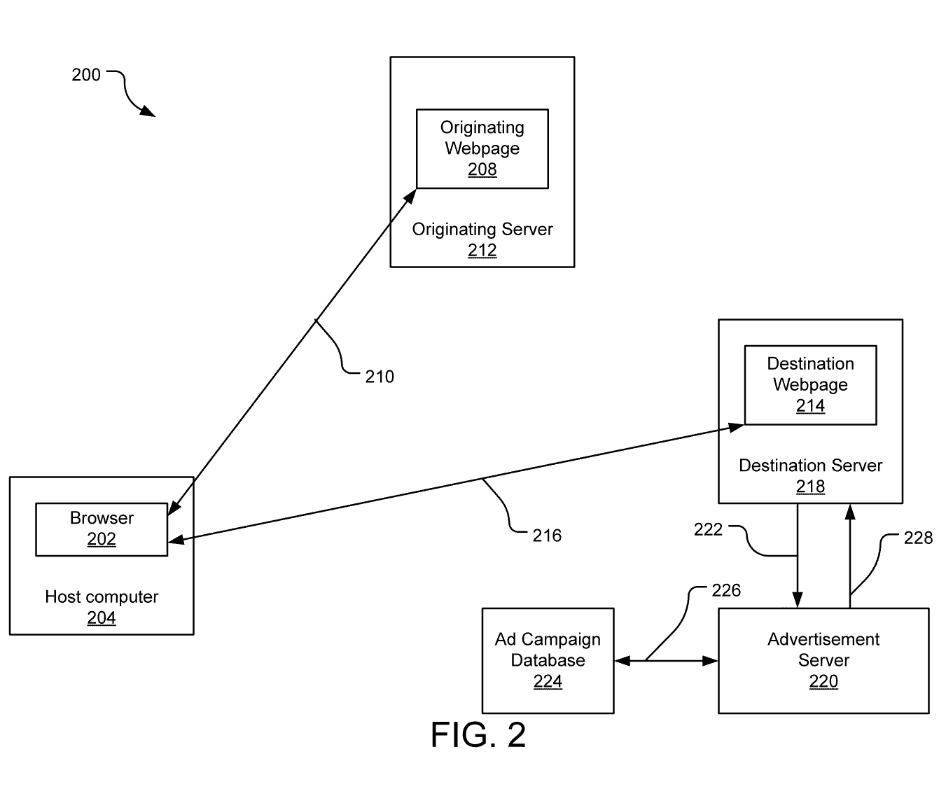

FIG. 2 illustrates an example flow diagram 200 for a referrer-based content server system according to an embodiment of the present invention. A user (not shown) may access networked content (e.g., a webpage, app store, remote application, etc.) via a browser 202 (e.g., Internet Explorer, Safari, Firefox, Google Chrome) running on a host computer 204 (e.g., a personal desktop computer, laptop computer, terminal, set-top box, client-based virtual machine, mobile device (e.g., a tablet computer, personal digital assistant (PDA), e-book reader, smart phone, smart watch or wearable, etc.), or any computing device having a central processing unit and memory unit capable of connecting to a network). A host computer 204 may also comprise a graphical user interface (GUI) or a browser application provided on a display (e.g., monitor screen, LCD or LED display, projector, etc.). Host computer 204 may vary in terms of capabilities or features. The host computer 204 may also include or execute an application to communicate content, such as, for example, textual content, multimedia content, or the like. The host computer 204 may also include or execute an application to perform a variety of possible tasks, such as browsing, searching, playing various forms of content, including locally stored or streamed video, or games. Host computer 204 may include or execute a variety of operating systems, including a personal computer operating system, such as a Windows, Mac OS or Linux, or a mobile operating system, such as iOS, Android, or Windows Mobile, or the like. The host computer 204 may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples.

The content is accessed via a network. The network may be any suitable type of network allowing transport of data communications across thereof. The network may couple devices so that communications may be exchanged, such as between servers and host/client devices or other types of devices, including between wireless devices coupled via a wireless network, for example. A network may also include mass storage, such as network attached storage (NAS), a storage area network (SAN), cloud computing and storage, or other forms of computer or machine readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Further, the host computer 204 may be networked over any combination of wired (e.g., Ethernet) or wireless (e.g., WiFi and Bluetooth) communication standards operating over a variety of different network types (e.g., Public Switched Telephone Network (PTSN), cable, satellite, cellular). Communications and content stored and/or transmitted to and from host devices may be encrypted using the Advanced Encryption Standard (AES) with a 256-bit key size, or any other encryption standard known in the art.

The user may navigate to a variety of webpages or other content via the browser 202 via a time-sequence (or series) of navigation. For example, the user may move from webpage A to webpage B to webpage C sequentially over a period of time. Similarly, the user may navigate a variety of app store offerings or remote applications sequentially over a period of time. The browser 202 can be configured to track the user's movement from one webpage to the next via one or more referrers as discussed above. The referrer(s) may be forwarded on to the next webpage or other content in the time sequence as the user navigates the content available via the network.

More specifically, the user may navigate to an originating webpage 210 via the user's browser 202, as illustrated by arrow 210. The originating webpage 210 content is served via an originating webpage server 212. The user may find one or more links on the originating webpage 210 that redirect the user to other webpages (e.g., a destination webpage 210). The user selects a link that aligns with the user's interests and the user's browser 202 is redirected to the destination webpage 214, as illustrated by arrow 216. The destination webpage 214 content is served via a destination webpage server 218.

The destination webpage 214 may include a variety of content, including links to additional webpages, informational content, and/or advertisements for goods and services. Some of the content may remain the same or cycle according to a fixed cycling schedule as the destination webpage 214 is periodically accessed. Other content may vary fully or in part depending on the referrer.

More specifically, on request from the browser 202 to access the destination webpage 214 content, the destination server 218 may query an advertisement server 220 to provide advertising content to be served to the user via the destination webpage 214, as illustrated by arrow 222. In other embodiments, the advertisement server 220 and the destination server 218 are implemented on the same server. The destination server 218 includes one or more referrers from the user's request to access the destination webpage 214 (e.g., a referrer associated with the originating webpage 208) in the query to the advertisement server 220.

Ad campaign database 224 can store advertising campaigns, the advertising campaigns including advertising structures containing key terms, the address of the landing page or pages to which the advertising campaign is directed to, impression limits, ad pricing, budget, and advertising content associated with the advertising campaign. The advertisement server 220 consults an ad campaign database 224 using referrers to select and retrieve appropriate advertisements for inclusion in the destination webpage 214 to be presented to the user, as illustrated by arrow 226. Thus, when the browser 202 accesses the destination webpage 214 from a given referrer, the advertisement server 220 can query the ad campaign database 224 with referrer identification (ID) associated with the given referrer to receive advertising content.

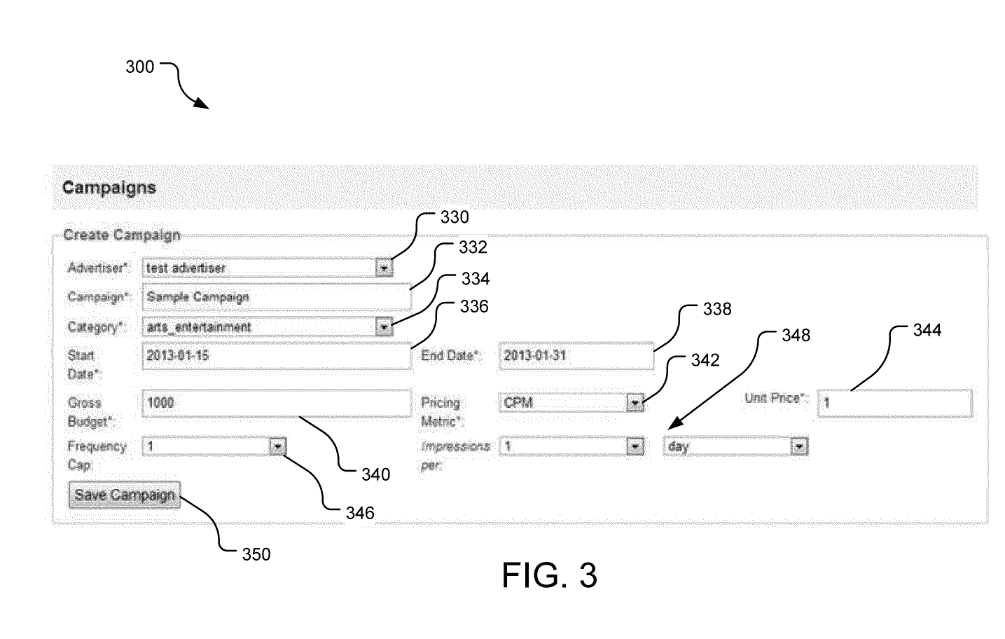

Selection of appropriate advertisements may be based on one or more referrers from the user's request to access the destination webpage 214. Details regarding ad campaigns stored on the ad campaign database 224 are discussed below with reference to FIG. 3. The advertisement server 220 sends the retrieved advertisement to the destination server 218, as illustrated by arrow 228. The destination server 218 loads the retrieved advertisement (and optionally, along with other advertisements) into the destination webpage 214 before the destination webpage 214 is presented to the user.

In one embodiment, the destination webpage 214 operator has contracted with a third party advertiser that provides advertising content to the destination webpage 214 via the advertisement server 220 to generate revenue for the operator of the destination webpage 214. In other embodiments, the advertiser is not a third party but the destination webpage 214 operator itself that is trying to maximize advertising revenue generated by the destination webpage 214. Still further, while the flow diagram 200 of FIG. 2 explicitly references advertising content, embodiments of the present invention may be applied to any other selectively presented content based fully or in part on one or more referrers.

Servers, as described herein, may vary widely in configuration or capabilities but are comprised of at least a special-purpose digital computing device including at least one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

The anonymity, ubiquity and stability of referrers make them an effective alternative or addition to cookies, IP addresses, and device fingerprints for managing and measuring R&F according to embodiments of present invention. Referrers do not require tracking browsers (e.g., the browser 202), computers (e.g., the host computer 204), or individual users, but instead represent an aggregated stream of users between web sites. Referrers are nearly universal, being available between most page views and are typically not deleted, blocked or changed. In comparison, cookies can and are deleted regularly. Further, IP addresses and device fingerprints can change at any time.

FIG. 3 illustrates an example advertising campaign creation screen 300 for creating a unique advertising campaign using referrers. The creation screen 300 illustrates several example attributes that may be assigned to the example advertising campaign. Other advertising campaigns may include one or more of the attributes illustrated in creation screen 300, as well as additional attributes not illustrated on creation screen 300. In one embodiment, the creation screen 300 is used to create an advertising campaign for the destination webpage 214 of FIG. 2.

An advertiser field 330 allows a user to select or enter an advertiser name/ID/identifier associated with an advertising campaign. In the illustrated embodiment, “test advertiser” is selected in advertiser field 330. A selected advertiser may have multiple advertising campaigns for one or more webpages (e.g., destination webpages). A campaign field 332 allows the user to select or enter an advertising campaign via a dropdown box or text input field (e.g., “Sample Campaign”) and/or allows the user to enter an advertising campaign associated with the advertiser ID. Still further, the selected advertising campaign may correspond to a number of advertising categories (e.g., “Arts & Entertainment”). A category field 334 allows the user to select an advertising category via a dropdown box and/or allows the user to enter an advertising category to be associated with the entered advertising campaign.

A start date field 336 and an end date field 338 allow the user to enter a desired timeframe for the advertising campaign. Here, the start date for the “Sample Campaign” is Jan. 15, 2013 and the end date is Jan. 31, 2013. According to an alternative embodiment, a duration field (not shown) may be entered in lieu of the end date field 338. In yet another embodiment, there may be an option to make the advertising campaign active for an indefinite period or for a selected number of advertising content presentations rather than a selected time period.

An advertiser can specify a maximum monetary value the advertiser is willing to pay for an action or impression, the maximum monetary value being the advertiser's “bid.” If ads from multiple advertisers can be displayed at one time, the order or relative placement of the ads can depend on the relative bids placed by each advertiser. A gross budget field 340 allows the user to set a maximum budget for the advertising campaign. Here, the gross budget for the “Sample Campaign” is $1000. An advertiser can set a budget, e.g., a monthly budget, with respect to a certain ad, such that once the budget has been expended due to a certain number of actions or impressions of the ad occurring, the ad is no longer displayed. For example, the advertising campaign may be set to automatically end at the sooner of expiration of the selected time period or exhaustion of the entered gross budget. In other embodiments, either the gross budget or the selected time period may alone define the duration of the advertising campaign.

A pricing metric field 342 allows the user to specify the cost type which the advertising campaign is to be calculated. Here, the pricing metric for the “Sample Campaign” is cost-per-thousand-impressions (CPM). In additional embodiments, the pricing metric may be cost-per-click (CPC), cost-per-action (CPA) or other similar metric. Ad pricing can vary for many reasons, some of which depend on the publisher of the ad. In some online advertising systems, advertisers pay for their ads on a CPC basis. A common way for advertisers to set a CPC is to take a target CPA and multiple it by an average click-through-rate (CTR) on a keyword. CPA is an online advertising return-on-investment (ROI) metric in which return is based solely on qualifying actions, such as a sale or registration, as measured against the marketing costs associated with reaching that sale or registration. Ad pricing may also be on a cost-per-impression basis, meaning a cost is incurred each time the ad is displayed.

A unit price field 344 defines the cost value associated with each presentation (or impression) of a selected advertisement via the advertising campaign. Here, the unit price for each presentation or impression of an advertisement in the “Sample Campaign” is $1. In one embodiment, the unit price field 344 is preset based on one or more of the other attributes (e.g., the advertiser and/or the category). In other embodiments, the unit price is negotiable at the time the advertising campaign is created. In still other embodiments, the unit price is variable and adjusts periodically based on a market value metric of the presentation of a selected advertisement.

Tracking user navigations and activities based on referrers can provide for a more accurate measurement of online content reach and frequency. Reach when measured by referrers can be a measure of unique URLs linking to a page (also called backlinks) rather than a number of “users” visiting a page. Frequency can be the number of page views associated with that referring URL rather than or in addition to the number of page views associated with a given browser, computer, or individual user. Consequently, referrer R&F can be expressed as a number of referring URLs multiplied by a number of page views (or ad views) in a given time period. According to embodiments of the present invention, referrer-based reach and frequency can be effectively used to manage advertising inventory yield. For example, a campaign may cap frequency at one impression per URL per day (corollary to one impression per user per day), where the “day” could be any unit of time.

A frequency cap field 346 defines the maximum number of impressions allocated for advertisements of a given advertiser campaign in a given period of time for a particular referrer ID. In the illustrated example, the frequency cap for the “Sample Campaign” is configured to ‘one’ for this advertiser campaign per referrer ID. In other embodiments, the frequency cap may be anything greater than one up to unlimited. According to another embodiment, specific referrers may be individually assigned customized frequency caps. For example, advertisements on Website A may be limited to one impression per day for requests associated with a referrer ID of Website B while advertisements on Website A may be limited to two impressions per day for requests to access Website A with a referrer ID of Website C. In yet another embodiment, frequency caps may be assigned to referrers based on their source classification (e.g., “search,” “content” and “direct”) or advertising categories. Analytic tools, engines and servers (e.g., FIG. 1) may be employed to determine frequency caps that are optimal or most cost efficient based on metrics such as rate of conversion associated with specific referrers. This can be advantageous to advertisers as some consumers from particular referrers may be determined to be more likely to make a conversion or purchase after seeing an advertisement than from other referrers.

An impression per field 348 defines a unit of time for a frequency cap set in field 346 for a particular referrer ID. In the illustrated example, the impression cap is set to per day per referrer ID. For example, advertisements on Website A are limited to one impression (allocated based on frequency cap field 346) per day (unit of time set in impression per field 348) for requests to access Website A with a referrer ID of Website B. Other units of time that may be selected for impression per field 348 include seconds, minutes, hours, weeks, months, or years. Once the impression cap (as specified by frequency cap field 346 and impression per field 348) has been met, advertising delivery based on a particular referrer for the selected timeframe (e.g., that particular day—impression field 348) may end. The advertising campaign for that referrer may resume the following timeframe.

In another embodiment, there are multiple possible advertisements associated with the advertiser. Once the impressions cap has been met for a particular advertisement, a new advertisement may be selected and presented until the impression cap has been reached for that particular referrer. For example, an ad impression coming from “referrer A” has two potential qualifying campaigns, “campaign A” with a frequency cap of one impression per referring URL per day and “campaign B” with a frequency cap of 10 impressions per URL per day. Assuming Campaign A and B have both already seen an impression from referrer A today, Campaign A no longer qualifies for this impression, leaving the impression for Campaign B.

Still further, each of the available advertisements associated with a particular advertiser may be presented randomly or sequentially, with advertisements being removed from the advertising queue when the impression cap has been reached for each particular referrer until no advertisements remain in the queue. In another embodiment, there is no specific cap for the advertising campaign. Instead, a frequency for presenting a specific ad may decrease as a rate a specific referrer ID is received by the advertising server increases, and vice versa. In other embodiments, the presentation rate adjustment may be used in conjunction with one or more caps on presentation of ads to users.

Still further, the advertising campaign may actively intersperse the available campaigns to a referrer such that the campaigns are exhausted at substantially the same time. For example, an ad impression coming from “referrer B” has two potential qualifying campaigns, “campaign C” with a frequency cap of 10 impressions per referring URL per day and “campaign D” with a frequency cap of 100 impressions per URL per day. Campaign C is randomly or sequentially presented roughly 10% of the time, while Campaign D is presented roughly 90% of the time that a request with referrer B is received. As a result, the 10 impressions of Campaign C and the 100 impressions of Campaign D are exhausted substantially simultaneously.

In a further embodiment, the referrer may also be used to select an advertisement category for presentation to a user based on a classification of the referrer webpage. For example, a referrer from www.espn.com may trigger an advertisement in a “Sports and Leisure” category, regardless of the destination webpage. According to other embodiments, certain attributes in fields 336 through 348 may be customized (or available) based on a selected advertising category.

Notable exceptions when a referrer might be absent from the request include users typing the destination web address directly in the user's browser or the user's accessing the destination site via bookmark, both of which are considered “direct navigation.” Further, in a small number of instances, the originating (or source) site may obscure the referrer. Still further, referrers can also become “lost” through the process of ad redirection or iframe nesting. In these situations, cookies, IP addresses, device fingerprinting, and/or other devices or methods may be used in lieu of the referrer information to provide effective advertising presentation. In other embodiments, absent referrers may be treated as unique sources and the error in R&F associated with this assumption is accepted as minimal.

Once the user is satisfied with the entered attributes of the “Sample Campaign,” the user may select the Save Campaign icon 350, which saves the “Sample Campaign” in a database (e.g., the ad campaign database 224 of FIG. 2). The database may store a variety of ad campaigns for different advertisers associated with different websites (see e.g., FIG. 2 for one such exemplary relationship).

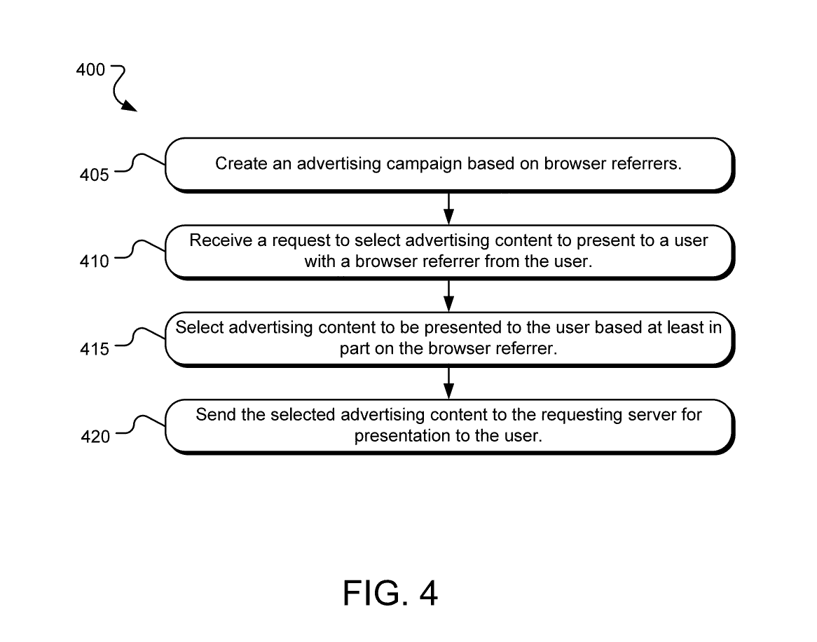

FIG. 4 illustrates example operations 400 for operating a referrer-based advertising campaign. In a creating operation 405, an advertisement server is able to create an advertising campaign based at least in part on browser referrals. The advertising campaign limits presentation frequency of selected ads based on distinct referrer IDs. Multiple advertising campaigns may be created using multiple iterations of creating operation 405. Once the advertising campaign(s) have been created, in a receiving operation 410, an advertisement server receives a request to select advertising content to present to a user. The request includes one or more referrer IDs from the user's browser.

In a selection operation 415, the advertisement server consults a database containing the advertising campaign(s) created using operation 405. Advertising content is selected to be presented to the user based at least in part on the referrer ID. For example, a particular advertising campaign may only allow the presentation of a particular ad in response to a request with a particular referrer ID for a discrete number of times in a particular time period. By allocating the presentation of particular ads based on referrer IDs, the advertisement server is able to efficiently distribute ads on the basis of improved user tracking. That is, the advertisement server is able to evenly distribute ads to unique users from different web browsing (or traffic) originations. Further, improved reach and frequency may be achieved over methods that rely solely on cookies, IP addresses and device fingerprinting, which provide unreliable user tracking and identification. In a sending operation 420, once an advertisement is selected, the advertisement server sends the selected advertisement to the requesting server for presentation to the user.

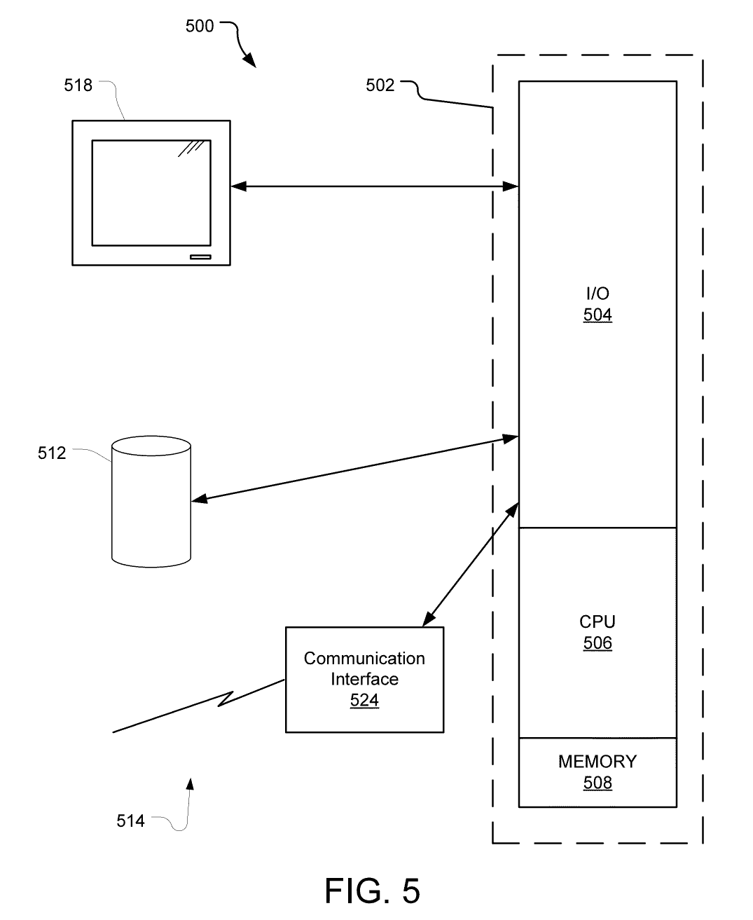

FIG. 5 illustrates a block diagram of a computer system 500 suitable for implementing one or more aspects of a referrer-based content presentation system. The computer system 500 is capable of executing a computer program product embodied in a tangible computer-readable storage medium to execute a computer process. Data and program files may be input to the computer system 500, which reads the files and executes the programs therein using one or more processors. Some of the elements of a computer system 500 are shown in FIG. 5, wherein a processor 502 is shown having an input/output (I/O) section 504, a Central Processing Unit (CPU) 506, and a memory section 508. There may be one or more processors 502, such that the processor 502 of the computing system 500 comprises a single central-processing unit 506, or a plurality of processing units. The processors may be single core or multi-core processors. The computing system 500 may be a conventional computer, a distributed computer, or any other type of computer. The described technology is optionally implemented in software loaded in memory 508, a disc storage unit 512, and/or communicated via a wired or wireless network link 514 on a carrier signal (e.g., Ethernet, 3G wireless, 4G wireless, LTE (Long Term Evolution)) thereby transforming the computing system 500 in FIG. 5 to a special purpose machine for implementing the described operations.

The I/O section 504 may be connected to one or more user-interface devices (e.g., a keyboard, a touch-screen display unit 518, etc.) or a disc storage unit 512. Computer program products containing mechanisms to effectuate the systems and methods in accordance with the described technology may reside in the memory section 504 or on the storage unit 512 of such a system 500.

A communication interface 524 is capable of connecting the computer system 500 to a network via the network link 514, through which the computer system can receive instructions and data embodied in a carrier wave. When used in a local area networking (LAN) environment, the computing system 500 is connected (by wired connection or wirelessly) to a local network through the communication interface 524, which is one type of communications device. When used in a wide-area-networking (WAN) environment, the computing system 500 typically includes a modem, a network adapter, or any other type of communications device for establishing communications over the wide area network. In a networked environment, program modules depicted relative to the computing system 500 or portions thereof, may be stored in a remote memory storage device. It is appreciated that the network connections shown are examples of communications devices for and other means of establishing a communications link between the computers may be used.

In one embodiment, the computer system 500 is used to implement a host server having a processor 502 communicatively coupled to a plurality of storage nodes (not shown) and/or one or more chassis-level controllers (not shown). In another embodiment, the computer system 500 is used to implement a storage node having a processor 502 that is communicatively coupled to processors of other storage nodes, one or more chassis-level controllers, or the host server. In yet another exemplary embodiment, the computer system 500 is configured to communicate with system storage nodes, a host computer, or a drive-level chassis by way of the communication interface 524, which may be an Ethernet port, USB connection, or other physical connection such as an I2C, SAS, SATA, or PLe connection.

Referrer-based content presentation operations and techniques may be embodied by instructions stored in memory 508 and/or the storage unit 512 and executed by the processor 502. Further, local computing systems, remote data sources and/or services, and other associated logic represent firmware, hardware, and/or software that may also be configured to perform such operations. Further, any one of the host computer, a chassis-level controller, or a distributed computing storage node may be implemented using a special-purpose computer and specialized software (such as a server executing service software), a special purpose computing system and specialized software (such as a mobile device or network appliance executing service software), or other computing configurations.

FIGS. 1 through 5 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A system comprising:
a server including a memory device having executable instructions stored therein and a processing device, in response to the executable instructions, configured to:
receive a content request from a destination webpage server, the content request including a Hypertext Transport Protocol (HTTP) header;
identify a referrer from a referrer field of the HTTP header, the referrer indicating an originating webpage;
determine a frequency the referrer has been identified from prior page requests in a given time period;
compare the frequency with a configuration value indicating a max frequency for presentation of one or more content to content requests associated with the referrer;
select content to be delivered to the destination webpage server based on the comparison; and
modify the content to be delivered based at least on exhausting the max frequency for presentation of one or more content to content requests associated with the referrer.

2. The system of claim 1 wherein the referrer includes an address of the origination webpage that links to a destination webpage served by the destination webpage server.

3. The system of claim 1 wherein the processing device is further configured to receive the content request corresponding to a redirection from the origination webpage to a destination webpage served by the destination webpage server.

4. The system of claim 1 wherein the content request includes a request for advertising content.

5. The system of claim 1 wherein the processing device is further configured to identify a series of referrers from the content request, the series of referrers comprising a time sequence of webpage navigations including the origination webpage.

6. A system comprising:
a content presentation server including a memory device having executable instructions stored therein and a processing device, in response to the executable instructions, configured to:
receive advertiser campaign criteria with target reach and frequency for the advertising campaign, the target reach and frequency including a maximum frequency of presentations to requests associated with unique referrer identifications (IDs);
allocate advertising content based on the advertiser campaign criteria;
receive requests from webpage servers for the advertising content, the requests including one or more referrers;
match the one or more referrers to the unique referrer IDs; and
select the advertising content for the webpage servers based on a satisfaction of the maximum frequency of presentations to requests associated with the unique referrer IDs.

7. The system of claim 6, wherein the content presentation server is an advertising content server and the advertising content is an advertisement for a good or service.

8. The system of claim 6 wherein the referrers include Hypertext Transport Protocol (HTTP) header fields that identify an address of a webpage that links to a resource being requested.

9. The system of claim 6 wherein the maximum frequency of presentations to requests associated with unique referrer identifications (IDs) includes a frequency cap that defines a maximum number of impressions allocated to advertising content from a given advertiser campaign in a given period of time for a given referrer ID.

10. The system of claim 9 wherein the given period of time includes at least one of seconds, minutes, hours, days, weeks, months, and years.

11. The system of claim 6 wherein the content presentation server is further configured to end the selection of the advertising content upon satisfaction of the maximum frequency of presentations to requests associated with the unique referrer IDs within a given period of time.

12. The system of claim 11 wherein the content presentation server is further configured to resume the selection of the advertising content in a period of time following the given period of time.

13. The system of claim 6 wherein the content presentation server is further configured to intersperse advertiser campaigns to a given referrer such that the advertiser campaigns are exhausted at substantially the same time.
